(19) United States
(12) Patent Application Publication
(10) Pub. No.: US 2025/0392376 A1
(43) Pub. Date: Dec. 25, 2025

(54) Method implemented by a network device for monitoring a resource usage to communicate with at least one terminal, and associated network device, terminal, system and computer program

(71) Applicant: ORANGE, ISSY-LES-MOULINEAUX (FR)

(72) Inventors: Jean-Marc KELIF, CHATILLON CEDEX (FR); Emile STEPHAN, CHATILLON CEDEX (FR); Véronica QUINTUNA RODRIGUEZ, CHATILLON CEDEX (FR)

(21) Appl. No.: 19/100,745

(22) PCT Filed: Aug. 2, 2023
(86) PCT No.: PCT/EP2023/071352

§ 371 Date: Feb. 3, 2025

(30) Foreign Application Priority Data
Aug. 5, 2022 (FR) FR2208135

(51) Int. Cl. H04B 7/185

(52) U.S. Cl. CPC H04B 7/18519; H04B 7/18521; H04B 7/18532; H04B 7/18565

(57) ABSTRACT

A method implemented by a network device for monitoring a resource usage to communicate with at least one terminal. The method includes: sending data to the at least one terminal; and sending, to a monitoring entity and/or to the at least one terminal, one or more usage proofs indicating resources used by the network device to communicate the data to the at least one terminal.

### TECHNICAL FIELD

The present invention relates to the general field of telecommunications. In particular, the present invention concerns a method implemented by a network device for monitoring a resource usage to communicate with at least one terminal, a method implemented by a terminal, a network device, a terminal, a monitoring entity, a system, a computer program and an information medium associated therewith. The present invention finds a particularly advantageous application, although in no way limiting, for the implementation of satellite mobile telephone networks.

### PRIOR ART

The invention falls in particular within the context of the delegation of resources between communication systems, a mechanism in which a first system makes resources (resources, radio, IT, network, etc.), such as for example a frequency spectrum, available to one or more other systems according to specific terms that define for example the resources concerned, the availability duration or period, usage parameters of these resources, and pricing or billing conditions for the usage of these resources.

The existing communication systems do not allow for reliable monitoring of the delegation of resources between different communication systems. For example, during interconnections of mobile networks or cellular networks, the operators of these networks cannot check that the delegation terms are met. Indeed, when an operator uses a radio access network (or RAN) of a third party, the operator cannot monitor the usage rights and the usage conditions of the spectrum dynamically. Existing solutions rely on spectrum property static proofs, e.g. an operator provides its spectrum licenses when it uses a radio access network of a third party. However, it appears necessary to be able to dynamically prove the ownership of a spectrum and also to monitor the usage of this spectrum for the communications.

For example, there are currently in the state of the art different communication systems that exploit satellites, and allow the users to access a network (e.g. the Iridium network, ViaSat, Starlink) regardless of their location. For example, it is known to use satellites in medium or low Earth orbits to deploy satellite communication systems. However, it should be noted that a communication system based on medium or low Earth orbit satellites requires a constellation of many satellites as well as many ground stations. However, to provide the users with continuous geographical coverage, it may be necessary for several satellites to cooperate with each other in order to communicate data to the terminals. It therefore appears essential, in order to implement such cooperation and delegate resources between satellites, to be able to dynamically prove the ownership of a spectrum and to monitor the usage of this spectrum for the communications.

Moreover, for the existing communication systems (e.g. terrestrial or satellite communication systems), the billing of the communications is typically performed statically by fixed-price contracts. Generally, the communications for a terminal are billed based on a maximum data volume authorized over a period of time (e.g. 10 GB/month). Existing billing solutions have a number of drawbacks that need to be addressed. In particular, such static billing solutions are not suitable for emerging usage cases, such as the networks of connected objects, the communicating vehicles, etc., which require more flexible billing solutions and not only based on the volume.

There is therefore a need for a solution to improve the traceability and the monitoring of the communications implemented by a communication system, particularly within a context of resource delegation.

### SUMMARY OF THE INVENTION

The present invention aims to overcome all or part of the drawbacks of the prior art, particularly those set out above.

To this end, according to one aspect of the invention, a method implemented by a network device for monitoring a resource usage to communicate with at least one terminal is proposed, the method comprising:
sending data to said at least one terminal; and
sending, to a monitoring entity and/or to said at least one terminal, one or more usage proofs indicating resources used by said network device to communicate said data to said at least one terminal.

The proposed method allows to achieve traceability of the resources used by a communication system to communicate data to a terminal. Indeed, the proposed method allows a network device (e.g. a satellite, an aircraft, a terrestrial radio access point, etc.) to dynamically inform a monitoring entity of the resources used. Compared to existing solutions, the proposed method particularly has the advantage of being dynamic.

By “network device”, reference is made here to a communication device of an access network, for example a radio access network, making it possible to communicate data to terminals. According to one embodiment, said network devices are comprised in aircrafts or satellites. Within the meaning of the invention, the terms “aircraft” and “satellite” refer respectively: to any device capable of rising into the air such as a drone, an airplane, a high altitude platform (or HAP); and to any device placed in orbit around a planet (Earth, Mars; . . . ) such as artificial satellites (e.g. telecommunications satellite). However, within the framework of the invention, other embodiments can be envisaged in which said network devices are terrestrial and are mobile or not.

Within the context of the invention, it should be noted that the expressions “from” and “to” in no way limit the nature of the interface between the sender and the recipient of a message, the link between these two entities being able to comprise intermediate equipment relaying the message. Also, the sending of the data to the terminal and the sending of the usage proofs to the terminal can be performed concomitantly or independently.

By “resource”, reference is made here to any resource of communication equipment and can thus designate communication resources (e.g. a frequency channel, a time slot, a pair consisting of a frequency and of a time interval, etc.), energy resources, computing resources, etc. In particular, the expression “resource used to communicate” can designate a resource used for all the operations necessary for the communication such as: emission, receipt, data processing, as well as synchronization and monitoring. Also, the usage proofs within the meaning of the invention indicate the communication resources actually used by the network devices to communicate data to the terminals. For example, a usage proof can indicate a number of frequency channels, a time interval, a number of time-frequency blocks, an emission power, and/or energy consumed to communicate data to the terminals. In particular, a usage proof is, according to one embodiment, a token-type message signed by the issuer (i.e. the author) of the proof, user of the resource.

The expression “monitoring entity” designates a device implementing a monitoring of the resources by a satellite communication system to communicate with terminals.

According to one embodiment, the resource usage proofs are sent to: a first monitoring entity comprised in a network device management entity, for example exploited by a mobile operator; and to a second monitoring entity comprised in a ground station, for example exploited by a network access device operator. In particular, the network device can send said resource usage proofs to the second monitoring entity; and the terminal can send said resource usage proofs, received from at least one network device, to the first monitoring entity. By “Ground station” it is meant network equipment located on Earth, making it possible to connect one or more network devices to a terrestrial communication network.

According to one embodiment, for each sending of data to a terminal, the terminal sends, to a monitoring entity, said one or more usage proofs indicating resources used during this communication. This embodiment allows to implement accurate monitoring of the resources with fine granularity (i.e. with a high level of detail). In addition, this embodiment allows to obtain a proof of the performance of a communication, since the monitoring entity receives the usage proofs from the terminal for which the communication has been performed.

As an example, the proposed method can particularly be advantageously exploited to deploy billing solutions based on the resources used. Such billing solutions appear to be essential to meet the needs of new usage cases for the communication systems, such as the connected object networks, the communicating vehicles, etc. In this example, the terminal receives both the data and the usage proofs indicating the resources used. The terminal can then transmit this information to a monitoring entity of a mobile network operator as proof of delivery of a communication; and the monitoring entity triggers the billing of this communication based on this information.

According to one embodiment, said network device sends, to a monitoring entity and/or to said at least one terminal, one or more usage proofs indicating resources used by at least one other network device to communicate said data to said at least one terminal.

It should be noted that the sending operations of the usage proofs relating to the different network devices can be performed concomitantly or independently.

This embodiment has particularly the advantage of monitoring the resources used by several network devices to communicate data to terminals. Hereinafter, the term “cooperation” is used to designate the fact that several network devices are used collaboratively to communicate with terminals.

In this embodiment, said usage proofs report the involvement of a plurality of network devices to communicate data to a terminal. Thus, this embodiment allows to trace the resources respectively used during cooperation between network devices.

As an illustration, an example is considered here in which a first network device requests a second network device in order to relay, to a terminal, part of the data to be transmitted to the latter. In this example, the usage proofs indicate the resources respectively used by each of the two network devices. In this way, the monitoring entity is able to trace the cooperation between the network devices, and particularly to monitor the resources used by the second network device to relay data to the terminal.

According to one embodiment, said one or more usage proofs are signed by a private key associated with a certified entity.

By “private key” and “public key” it is meant a pair of keys associated with an entity and used to implement an asymmetric encryption scheme, the private key being intended to be confidential and the public key being intended to be publicly disseminated. In one particular embodiment of the invention, an encryption scheme is particularly used to generate session keys authenticating the messages such as usage proofs and usage authorizations.

By “signature” reference is here made to a digital signature, i.e. data added to a message, allowing the recipient of the message to check the author of this message as well as the integrity of the latter. The signature of a message is, according to one embodiment, obtained by encrypting a hash of the message. Thus, upon receipt of the message, the recipient simply needs to decrypt the signature of the message, then compare the decrypted signature to a hash of the message received to ensure the authenticity and the integrity of the message.

Furthermore, within the context of the invention, a “certified entity” designates an entity authorized to exploit resources and having, as such, a certificate. By way of illustration, a certified entity can be a mobile operator owning a certain frequency spectrum and authorizing network devices to exploit this spectrum in order to communicate with terminals. In particular, the resource usage proofs sent by the network devices can be signed with a private key of the operator of the network devices, or can be signed by using an algorithm based on an identifier of the operator, for example deriving an encryption key from this identifier.

One advantage of this embodiment is to guarantee the reliability of the monitoring of the use of the resources. Indeed, this embodiment ensures the authenticity and the integrity of the transmitted usage proofs relating to the resources used. Any recipient of these usage proofs is able to check the authenticity and non-repudiation of the information by using the public key of the certified entity.

For example, an operator can have a private key-public key pair allowing it to prove that it owns a frequency spectrum. In particular, a frequency regulatory authority (e.g. the regulatory authority for electronic communications, postal affairs and print media distribution or ARCEP for “autorité de régulation des communications électroniques, des postes et de la distribution de la presse” in French, or the GSMA) signs a public key certificate (e.g. an X.509 certificate) for each spectrum (e.g. a certificate for each carrier of a radio access network) owned by an operator. This certificate of the operator allows it to disseminate a certificate by access network or RAN (Radio Access Network) including its public key with the signature of a regulatory authority (i.e. trusted). As a result, the recipients (user network devices) are thus able to authenticate the spectrum ownership information signed by this operator.

According to one embodiment, said one or more usage proofs indicate frequency resources used to communicate data to said at least one terminal. This embodiment allows to reliably and accurately monitor the frequency resources used by one or more network devices during a communication with terminals.

In combination with one or more of the preceding embodiments, this embodiment allows particularly to monitor the frequency resources delegated during cooperation between network devices. This embodiment is particularly advantageous in that it allows, when a network device delegates (i.e. makes available) part of its resources to cooperate with at least one other satellite, to prove the delegation of resources.

According to one embodiment, said one or more usage proofs indicate time-frequency resources used to communicate application data to said at least one terminal and associated control data.

In this embodiment, a distinction is made between the use of resources to communicate application data (or useful data) and the use of resources to communicate control data. By “application data”, reference is made here to data of a communication service (i.e. function), for example data of a telephone communication, data of a video stream, etc. And, by “control data”, reference is made here to data necessary for the implementation of a communication service (i.e. function), such as signaling data, synchronization data, etc.

This embodiment allows to perform accurate monitoring of the resources used, particularly by differentiating the monitoring of the resources used to communicate application data and to communicate control data. It should be noted that the communications of these two types of data are typically implemented by using distinct resources, such that this embodiment allows to account for the use of these different resources.

This embodiment is particularly advantageous because it allows to monitor both the resources used for the communication of the useful data and also the resources used for the implementation of this communication, e.g. signaling, synchronization, etc. For example, within the framework of cooperation between network devices, a number of exchanges are necessary between the different network devices to implement this cooperation. This embodiment allows, in this case, to account for these exchanges in the monitoring of the resources used. Furthermore, this embodiment allows to gradually initiate the exchanges between network devices over time without intervention of the management entities of the network devices, even when the network devices are exploited by different operators. This embodiment thus allows the network devices to receive, check and account for the usage proofs over time.

According to one embodiment, said one or more usage proofs indicate an amount of energy resources consumed to communicate said data to said at least one terminal. This embodiment allows to account, in the monitoring of the resources used, for the energy resources consumed by one or more network devices to communicate data to a terminal.

According to one embodiment, the network device sends all or part of said data to said at least one terminal via at least one other network device.

This embodiment allows to improve the performance of a satellite communication system (e.g. a satellite access network), particularly in terms of coverage, rate and reliability.

Indeed, this embodiment allows to implement cooperation between network devices in order to communicate with terminals, i.e. several network devices are used to communicate data to the terminals. Such cooperation allows a network device to benefit, thanks to the cooperation, from the resources of at least one other network device to communicate with terminals. Such cooperation allows, for example, the network device to artificially expand its coverage area by benefiting from the coverage area of at least one other network device.

This embodiment allows to increase the power of the signal received by a terminal. For example, a first network device can increase the power of the signal received by a terminal by cooperating with a second relay network device (i.e. repeater) closer to the terminal.

According to one embodiment, said sending of all or part of said data to said at least one terminal via said at least one other network device is triggered following a receipt of a usage query message received from said at least one terminal.

According to one embodiment, said message received from said at least one terminal comprises information relating to a power level received by said at least one terminal. No limitation is attached to the nature of the information relating to a received power level. It can particularly take the form of a request to increase the received power, a received power level, a Signal-to-Interference-plus-Noise Ratio (or SINR), an indication that the received power level is below a given threshold.

According to one embodiment, sending said data by said network device to said at least one terminal comprises:
sending a first portion of said data to said at least one terminal; and
sending, to at least one other network device, a second portion of said data to be transmitted to said at least one terminal.

It should be noted that, in this embodiment, the expressions “first portion of said data” and “second portion of said data” can designate all or part of said data to be transmitted to said at least one terminal. Furthermore, the first and second data portions can be identical in whole or in part, or different.

In this embodiment, a plurality of point-to-point links is used to transmit data to the terminals.

Thus, this embodiment allows particularly to exploit coordinated multi-point techniques, more commonly designed by COMP (Coordinated Multi-Point). By thus exploiting the spatial domain of the communication channel, this embodiment allows to benefit from the respective advantages of the spatial diversity or spatial multiplexing schemes, which are respectively: increasing the reliability and the range; and increasing the rate of the communications. Consequently, this embodiment allows to improve the communication performance in terms of coverage, rate and reliability.

Furthermore, this embodiment allows to implement frequency and/or time multiplexing techniques and thus allows to increase the communication rate. For example, the two network devices can transmit two independent data streams to the terminals by exploiting all or part of two distinct frequency bands so as to increase the transmission rate.

According to one embodiment, said method comprises:
sending, to said at least one network device, a query to transmit data to said at least one terminal, the transmission query comprising one or more usage proofs indicating resources used by said network device; and
receiving, from said at least one other network device, a response comprising one or more usage proofs indicating resources used by said at least one other network device.

This embodiment falls within the context of cooperation between network devices described above. In this embodiment, at least two network devices cooperate (i.e. are used) to communicate data to the terminals. In particular, when two network devices cooperate, this embodiment allows each of the two network devices to have usage proofs indicating the resources used by the two network devices. Thus, each of the network devices is able to trace the resources used by several network devices during a cooperation and to prove this cooperation.

As an illustration, a cooperation between two satellites (network devices within the meaning of the invention) exploited by distinct mobile network operators is considered. One of the operators delegates part of its resources (e.g. a frequency spectrum) to the other operator in order to communicate data to terminals. Thanks to this embodiment, each of the operators is able to reliably and accurately monitor the resources used by the two network devices, and particularly the delegated resources.

According to one embodiment, the method comprises:
receiving, from a certified entity, a public key associated with the certified entity;
receiving, from the certified entity, an authorization to use at least one resource comprising a signature determined from a private key associated with the certified entity; and
authenticating said authorization from the received signature and public key.

As described above, by “authentication” it is meant the fact of checking the identity of the author of a message or of a data and further the integrity of this message or of the data, and particularly, at least in this embodiment, the certificate associated with the use authorization.

This embodiment allows to reliably and securely monitor the exploitation of resources. Indeed, in this embodiment, a certified entity authorizes a network device to use some resources to communicate with terminals. It is for example the owner of a satellite spectrum or 4G or 5G.

For example, the use (or exploitation) authorization can indicate to a network device that it can exploit a certain frequency spectrum to communicate with terminals. Such a use authorization can be issued by an operator owning this spectrum and having a public key certificate as described above. In this way, if a network device receives an authorization to use this spectrum, it is able to authenticate this authorization and to confirm that the owner operator is indeed the author of this information and that it delegates its usage to the network device for the duration indicated in the authorization. This type of delegation is for example performed using protocols such as the STAR protocol as described in the RFC 8555 document published by the IETF dating from March 2019, or the Subcert protocol described in the document published by the IETF and entitled “Delegated Credentials for (D) TLS—draft-ietf-tls-subcerts-15”, 15 Jun. 2022.

According to one embodiment, which finds one particular but non-limiting advantage within the framework of a cooperation mentioned above between a first and at least one second network device—for example between two satellites, the method comprises:
receiving, by a first network device from a management entity of this cooperation, information relating to resources of at least one second network device that can be used to transmit data to said at least one terminal;
if a criterion called cooperation criterion is checked, triggering a cooperation with said at least one other network device as a function of said information to transmit data to said at least one terminal, said cooperation comprising sending, to said at least one other network device, data to be transmitted to said at least one terminal.

By “cooperation criterion”, it is here meant a criterion that conditions the implementation of a cooperation by the first network device with the second network device. Hereinafter, the resources of a network device which can be used for a cooperation are also called shareable or usable resources.

This embodiment allows to improve the performance of a communication system, particularly in terms of coverage, rate and reliability. Indeed, this embodiment allows to implement cooperation between network devices in order to communicate with terminals.

This embodiment allows a network device to implement cooperation autonomously and dynamically with other network devices, which allows to respond to rapid rate variations in the data to be communicated to the terminals. In addition, this embodiment requires only minimal and decorrelated signaling (of said rapid rate variations) between the cooperation entity and the network devices to implement cooperation.

The autonomy, i.e. the initiative capacity, of the network devices with regard to the implementation of the cooperation is enabled by sending them information relating to the resources that can be used to cooperate. Indeed, during the validity duration of the received information, the network devices have the information required to initiate a cooperation if necessary. This embodiment thus allows to implement a low-complexity communication system to perform cooperation between network devices, for example between satellites.

The autonomy of the network devices with regard to the implementation of the cooperation can also be enabled by sending resource delegation authorizations to a network device. Following the receipt of these authorizations, a network device is for example informed that another network device is authorized to cooperate and can thus initiate a cooperation if necessary with this other network device. This embodiment can be qualified as an “opportunistic” cooperation mode.

According to another aspect of the invention, a method implemented by a terminal for monitoring a resource usage to communicate with at least one network device is proposed, the method comprising:
receiving data from said at least one network device; and
receiving, from said at least one network device, one or more usage proofs indicating resources used by said at least one network device to communicate said data to the terminal.

According to one embodiment, the terminal sends said usage proofs to a monitoring entity.

According to another aspect of the invention, a network device for communicating with at least one terminal is proposed, comprising:
a sending module configured to send data to said at least one terminal; and
a sending module configured to send, to a monitoring entity and/or to said at least one terminal, one or more usage proofs indicating resources used by said network device to communicate said data to said at least one terminal.

According to another aspect of the invention, a terminal is proposed comprising:
a receiving module configured to receive, from at least one network device, data and one or more usage proofs indicating resources used by said at least one network device to communicate said data to the terminal.

According to one embodiment, the terminal further comprises a sending module configured to send said usage proofs to a monitoring entity.

According to another aspect of the invention, a monitoring entity is proposed comprising:
a receiving module configured to receive, from at least one network device and/or from at least one terminal, one or more usage proofs indicating resources used by said at least one network device to communicate data to said at least one terminal.

According to one aspect of the invention, a system is proposed comprising:
at least one network device in accordance with the invention; and
at least one terminal in accordance with the invention.

The characteristics and advantages of the method implemented by a network device in accordance with the present invention described above also apply to the network device, to the method implemented by a terminal, to the terminal, to the monitoring entity and to the system proposed.

According to one embodiment, the system further comprises a monitoring entity in accordance with the invention.

According to one aspect of the invention, a computer program is proposed including instructions for the implementation of the steps of a method in accordance with the invention, when the computer program is executed by at least one processor or one computer.

The computer program can be formed of one or more sub-parts stored in the same memory or in distinct memories. The program can use any programming language, and be in the form of source code, object code, or intermediate code between source code and object code, such as in a partially compiled form, or in any other desirable form. Furthermore, the computer program can be executed on at least one processor or one computer on board a satellite or an aircraft or any other network device.

According to one aspect of the invention, a computer-readable information medium comprising a computer program in accordance with the invention is proposed.

The information medium can be any entity or device capable of storing the program. For example, the medium can include a storage means, such as a non-volatile memory or ROM, for example a CD-ROM or a microelectronic circuit ROM, or a magnetic recording means, for example a floppy disk or a hard disk. On the other hand, the storage medium can be a transmissible medium such as an electrical or optical signal, which can be conveyed via an electrical or optical cable, by radio or by a telecommunications network or by a computer network or by other means. The program according to the invention can in particular be downloaded from a computer network. Alternatively, the information medium can be an integrated circuit in which the program is incorporated, the circuit being adapted to execute or to be used in the execution of the method in question.

### BRIEF DESCRIPTION OF THE DRAWINGS

Other characteristics and advantages of the present invention will emerge from the description provided below of embodiments of the invention. These embodiments are given for illustrative purposes and are not limiting. The description provided below is illustrated by the attached drawings:

FIG. 1 schematically represents a communication system for illustrating cooperation implemented between network devices within a context of application of the invention;

FIG. 2 represents, in the form of a flowchart, steps of a communication method for illustrating cooperation implemented between network devices within a context of application of the invention;

FIG. 3 represents, in the form of a flowchart, steps of a communication method according to one embodiment of the invention;

FIG. 4 represents, in the form of a flowchart, steps of a communication method according to one embodiment of the invention;

FIG. 5 schematically represents one example of software and hardware architecture of a communication system according to one embodiment of the invention;

FIG. 6 schematically represents one example of functional architecture of a communication system according to one embodiment of the invention.

### DESCRIPTION OF EXAMPLE EMBODIMENTS

The present invention concerns a method implemented by a network device for monitoring a resource usage to communicate with at least one terminal, a method implemented by a terminal, a network device, a terminal, a monitoring entity, a system, a computer program and an information medium associated therewith.

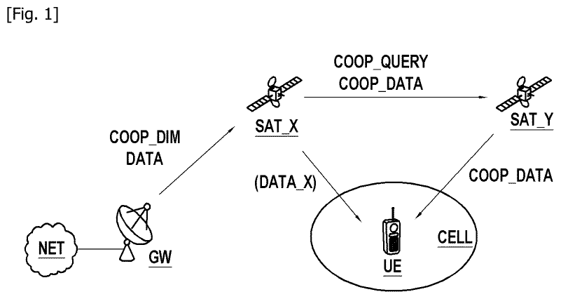

The present invention applies in particular to the satellite communication systems, as described below with reference to FIGS. 1 to 6. However, the invention also applies to any type of communication systems, particularly terrestrial or aircraft communication systems.

FIG. 1 schematically represents a communication system making it possible to illustrate cooperation implemented between network devices within a context of application of the invention.

In this embodiment, the present invention takes place in a context where several satellites (network devices within the meaning of the invention) cooperate to communicate data to terminals. FIG. 1 illustrates several types of cooperation between network devices.

As illustrated in FIG. 1, the satellite communication system comprises according to one embodiment: a ground station GW; a first satellite SAT_X; a second satellite SAT_Y and at least one terminal UE. The communication system transmits data from a communication network NET to said at least one terminal UE, said at least one terminal UE being comprised in a cell CELL. To do so, the communication system implements an inter-satellite cooperation: several satellites SAT_X and SAT_Y of the communication system are thus used to communicate data to said at least one terminal UE.

The term “cell” is used here to designate a terrestrial geographical region covered by a beam of one of the antennas of the communication network device or by a beam of one of the antennas of a terrestrial mast, the terrestrial mast being able for example to be operated by an infrastructure management entity of a radio access network (more commonly designated by “TowerCo”, abbreviation for “TowerCompany”). The geographical region covered includes the volume consisting of the cone of the beam.

According to a first embodiment, the inter-satellite cooperation is of the relay type, the second satellite SAT_Y being exploited as a relay between the first satellite SAT_X and said at least one terminal UE. This first embodiment allows particularly to enlarge the coverage area of the communication system, the first satellite SAT_X “artificially” benefiting from the coverage area of the second satellite SAT_Y to communicate with terminals UE. Furthermore, this embodiment allows to increase the power of the signal received by said at least one terminal UE, typically by selecting a relay satellite SAT_Y closer to the cell CELL in which the terminal UE is located, which thus allows to improve the reliability and/or the rate of the communications.

In this first embodiment, the ground station GW is configured to communicate with the communication network NET. To implement a relay-type cooperation, the ground station GW sends, to the first satellite SAT_X, information COOP_DIM relating to resources of the second satellite SAT_Y that can be used to transmit data in the cell CELL, and therefore that can be used within the framework of the inter-satellite cooperation. According to one exemplary implementation, the information COOP_DIM corresponds to a number of available channels of the second satellite SAT_Y. The ground station GW further sends, to the first satellite SAT_X, data DATA to be communicated to said at least one terminal UE. These data DATA here comprise a first set of data COOP_DATA and a second set of data DATA_X, detailed below.

No limitation is attached to the origin of the data COOP_DATA to be transmitted. It can be envisaged within the framework of the invention that the data to be transmitted to the terminals are generated by the network devices. Thus, according to one embodiment, the data COOP_DATA to be transmitted to said at least one terminal UE are emitted or transmitted by the satellite SAT_X.

The first satellite SAT_X thus receives, from the ground station GW, the information COOP_DIM and the data DATA. Based on the information COOP_DIM, the first satellite SAT_X sends, to the second satellite SAT_Y, a query COOP_QUERY to transmit data to said at least one terminal UE and the data COOP_DATA to be transmitted to said at least one terminal UE. Hereinafter, the query COOP_QUERY to transmit data to said at least one terminal UE is also called cooperation query.

The second satellite SAT_Y receives, from the first satellite SAT_X, the cooperation query COOP_QUERY and the data COOP_DATA to be transmitted to said at least one terminal UE. Following this receipt, the second satellite SAT_Y sends the data COOP_DATA to said at least one terminal UE.

Said at least one terminal UE receives, from the second satellite SAT_Y, the data COOP_DATA.

The invention thus allows, in this first embodiment, to implement inter-satellite cooperation initiated by the satellites themselves autonomously. As a result, the invention requires only a few exchanges between the ground station and the satellites to implement cooperation, which particularly allows to deploy a satellite communication system with a limited number of ground stations. Furthermore, the invention allows, thanks to the autonomy of the satellites, to implement inter-satellite cooperation opportunistically and dynamically, and allows to respond to rapid rate variations.

By way of illustration, the present invention can be exploited to implement mobile telephone networks based on radio access technologies of the OFDMA (Orthogonal Frequency Division Multiple Access) type.

No limitation is attached to the nature of the communication network NET, which can be a mobile telephone network (2G, 3G, 4G, 5G, 6G, etc.), an Internet-type computer network, or any other network (owner, etc.) that can be envisaged. The communication interface between the network NET and the ground station GW can be wired or non-wired, and can implement any protocol known to those skilled in the art.

No limitation is attached to the nature of the communication interfaces between: the ground station GW and the first satellite SAT_X; and between the first satellite SAT_X and the second satellite SAT_Y. In particular, according to one embodiment, one or more intermediate satellites are used to relay the data from the ground station GW to the first satellite SAT_X and/or from the first satellite SAT_X to the second satellite SAT_Y.

In accordance with the invention, the satellites of the communication system SYS can describe geostationary, medium or low Earth orbits. As a result, the coverage areas of the different satellites can be stationary or moving over time. Moreover, it is important to note that the satellites of the communication system can be exploited by the same satellite operator or by different satellite operators. In the latter case, the communication system allows to implement cooperation between several mobile and/or satellite operators.

The terminals UE can be of the mobile telephone type, for example a Smartphone, or a tablet, or a computer or any other type of communicating device, particularly communicating objects (more commonly designated by IoT for Internet of Things).

According to a second embodiment, the inter-satellite cooperation implemented by the communication system is of the CoMP (Coordinated Multi-Point) type. According to this second embodiment, the first satellite SAT_X and the second satellite SAT_Y are exploited to transmit data DATA_X and COOP_DATA to said at least one terminal UE in a coordinated manner, by using the same time-frequency resources. This second embodiment allows to exploit the spatial domain of the communication channel to improve the communication performance in terms of coverage, rate and/or reliability. According to this embodiment, the satellites SAT_X and SAT_Y coordinate their sending operations so that, at the level of said at least one terminal UE, the receipt of the data DATA_X from the first satellite SAT_X is synchronized with the receipt of the data COOP_DATA from the second satellite SAT_Y.

No limitation is attached to the nature of the data DATA_X and COOP_DATA respectively sent by the first satellite SAT_X and the second satellite SAT_Y. Furthermore, the data DATA_X and COOP_DATA can be identical or different. It should be noted that, according to one embodiment, the data COOP_DATA and DATA_X are comprised in the data DATA.

According to a third embodiment, the inter-satellite cooperation implemented by the communication system is of the carrier aggregation type. In this third embodiment, the first satellite SAT_X and the second satellite SAT_Y are exploited to simultaneously send data DATA_X and COOP_DATA to said at least one terminal UE by using different frequency resources. This third embodiment allows to implement frequency multiplexing, and thus improve the transmission rate.

According to a fourth embodiment, the inter-satellite cooperation consists in exploiting the second satellite SAT_Y as a relay to perform a control transfer, qualified as long handover, of said at least one terminal from the first satellite SAT_X to a third satellite. This fourth embodiment allows to enlarge the coverage area of the communication system and to ensure continuity of service for the terminals. In this fourth embodiment, the control switchover from the terminal UE to the third satellite can be performed as follows: during a first time interval, the ground station GW sends, to the first satellite SAT_X, data to be transmitted to said at least one terminal UE, these data being transmitted to the terminal UE via the second satellite SAT_Y; then, during a second subsequent time interval, the ground station GW sends, to the third satellite, other data to be transmitted to the terminal UE. Thus, the ground station GW switches the data stream to the terminal UE from the first satellite SAT_X to the third satellite.

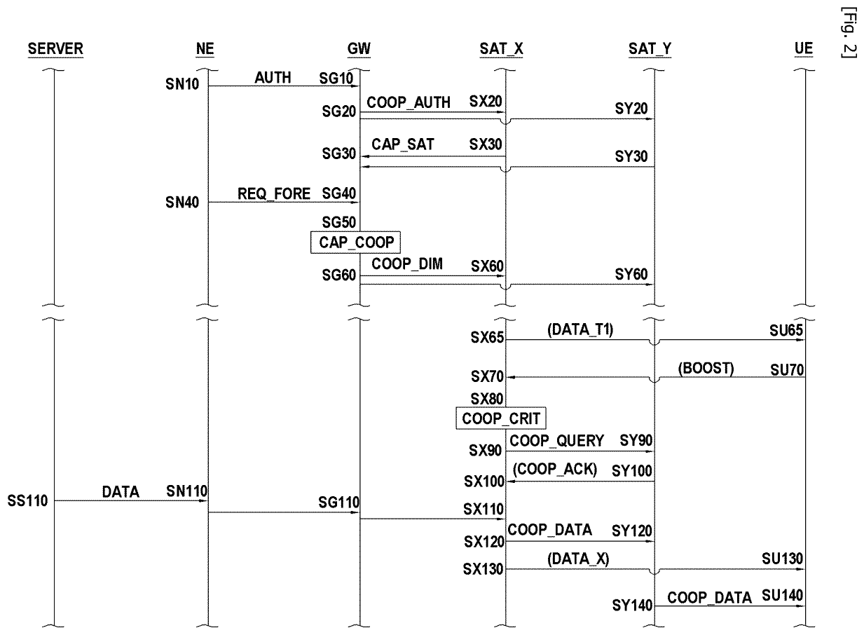

FIG. 2 represents, in the form of a flowchart, steps for illustrating cooperation implemented between network devices within a context of application of the invention.

As mentioned previously, the present invention falls within a context where several network devices cooperate to communicate data to terminals and applies in particular to the satellite communication systems. FIG. 2 thus describes the exchanges between the elements of a communication system implementing cooperation between satellites according to the embodiments of the invention described previously with reference to FIG. 1.

In the embodiment illustrated in FIG. 2, the communication system comprises a server SERVER; a network entity NE; a ground station GW; a first satellite SAT_X; a second satellite SAT_Y; and at least one terminal UE.

FIG. 2 describes steps implemented by the different elements of the communication system according to one embodiment and illustrates over time data exchanges between these elements. The following reference signs allow, for each of the steps of the method, to identify the element implementing this step: the references starting with SS are used for the steps implemented by the server SERVER; SN for the network entity NE; SG for the ground station GW; SX for the first satellite SAT_X; SY for the second satellite SAT_Y; SU for said at least one terminal UE.

According to this embodiment, the server SERVER is an application server emitting data DATA to said at least one terminal UE. For example, the server SERVER can be a mobile telephone server, or a web server. However, within the framework of the invention, other embodiments can be envisaged in which the first satellite SAT_X generates the data DATA to be transmitted to said at least one terminal UE.

According to this embodiment, the network entity NE is exploited by a mobile operator called MNO (Mobile Network Operator), while the ground station GW is exploited by a satellite operator called SNO (Satellite Network Operator).

During a step SG10, the ground station GW receives, from the network entity NE, resource delegation authorizations AUTH (sent during a step SN10). The resource delegation authorizations AUTH specify the communication resources that can be exploited by the network devices (such as satellites) to cooperate. The authorizations AUTH are for example sent by one or more mobile operators MNO and specify the spectra and the spots that can be exploited by the satellites to cooperate.

During a step SG20, the ground station GW sends cooperation authorization COOP_AUTH (received during steps SX20 and SY20) to the satellites SAT_X and SAT_Y. As an illustration, a cooperation authorization COOP_AUTH authorizes the second satellite SAT_Y to cooperate with the first satellite SAT_X and vice versa.

During a step SG30, the ground station GW receives, from the satellites SAT_X and SAT_Y, information CAP_SAT relating to the resources of the satellites SAT_X and SAT_Y (sent during steps SX30 and SY30). For example, for a satellite SAT_X, the information CAP_SAT can designate the available frequency channels estimated by the module CAP_COOP to transmit data to said at least one terminal UE.

During a step SG40, the ground station GW receives, from the entity NE, information REQ_FORE relating to specifications of the communication system (sent during a step SN40). For example, the information REQ_FORE is emitted by a mobile operator MNO and corresponds to forecasts of needs to implement a communication service, in terms of target rate, outage probability, and number of connections required over a period of time.

In particular, a module CAP_COOP of the ground station GW receives the information CAP_SAT and REQ_FORE for a group of satellites: SAT_X, and/or SAT_Y. The information COOP_DIM, described in more detail later, is determined by this module CAP_COOP. According to one embodiment, the module CAP_COOP is common to the satellites SAT_X and SAT_Y. According to other embodiments, there is a module CAP_COOP per group of satellites. The communication system can comprise one or more operational/functional support systems (or OSS/BSS acronym for “Operational Support System/Business Support System”) per satellite operator SNO or mobile operator MNO. Thus, depending on the architecture of the communication system (one or more OSS/BSS per MNO or SNO), a group of satellites can comprise either the group of satellites seen by a ground station GW, or all the satellites of a constellation), e.g. a module CAP_COOP for each of the satellites SAT_X and SAT_Y.

During a step SG50, the ground station GW determines, by using the module CAP_COOP, information COOP_DIM relating to the resources of the satellites that can be used for a cooperation. According to one embodiment, the information COOP_DIM corresponds to the numbers of free channels of the satellites, these free channels being able to be used for a cooperation.

According to one embodiment, the information COOP_DIM is determined by the module CAP_COOP of the ground station GW during a step SG50 based on the information CAP_SAT and REQ_FORE. In particular, the information COOP_DIM for the satellite SAT can be determined from a transmission rate D and an outage probability P_OUT relating to the service of the satellite SAT, the rate D and the outage probability P_OUT being comprised in the information REQ_FORE. The information COOP_DIM can further be determined from a statistic of the communication channel between the satellite and a terminal.

During a step SG60, the ground station GW sends the information COOP_DIM (received during steps SX60 and SY60) to the satellites SAT_X and SAT_Y. For example, the information COOP_DIM is sent to the satellite SAT_X and indicates to it that the satellite SAT_Y has a plurality of channels that can be used to transmit data in the cell CELL. It should be noted that when the satellites SAT_X and SAT_Y belong to different constellations then the information COOP_DIM relating to the first satellite SAT_X can be transmitted to the ground station in charge of the second satellite SAT_Y and vice versa.

During a step SX65, according to one particular embodiment, the first satellite SAT_X sends data DATA_T1 (received during a step SU65) to said at least one terminal UE.

During a step SX70, according to one particular embodiment, the first satellite SAT_X receives, from said at least one terminal UE, a usage query message named BOOST (sent during a step SU70). The usage query BOOST includes a parameter that can particularly designate a request to increase the power of the received signal by N dB (decibels), a power level of the received signal, or indicate that the power of the received signal is below a threshold, etc. For example, the usage query BOOST is a signal-to-interference-plus-noise ratio, more commonly designated by SINR, at the level of the terminal UE for a signal received from the first satellite SAT_X. As an illustration, this usage query BOOST is for example issued by a terminal UE (e.g. an aging connected object) whose receipt is deteriorating. This usage query BOOST is signed by the terminal and thus represents a commitment of the terminal UE to “pay” the costs associated with the action implemented to process the usage query of the terminal UE. The receipt of the usage query message issued by the terminal UE, for example in the form of a token signed by the terminal UE, by a monitoring entity (e.g. satellite and/or mobile entities) via the signaling channel of the satellite SAT_X allows to prove a usage (i.e. communication) query emanating from the terminal UE associated with the signal-to-interference-plus-noise ratio SINR.

During a step SX80, the first satellite SAT_X determines a cooperation criterion COOP_CRIT. The criterion COOP_CRIT conditions the initialization of a cooperation by the first satellite SAT_X with the second satellite. In particular, the first satellite SAT_X thus determines in step SX80 whether a cooperation is necessary.

A first exemplary implementation of step SX80 is described here. Following the receipt of the usage query BOOST in step SX70, the first satellite SAT_X determines that a cooperation is required and, based on the information COOP_DIM, sends a cooperation query COOP_QUERY to the second satellite SAT_Y. According to this first example, the receipt of the usage query is sufficient to check the cooperation criterion COOP_DIM and implement a cooperation.

According to a second example, the first satellite SAT_X encounters a peak load (i.e. an increase in the data rate) over a given period of time. In this example, the first satellite SAT_X does not have sufficient frequency resources to communicate all of the data to the terminals, and determines that a cooperation is necessary.

More generally, the cooperation criterion COOP_CRIT can be determined by the first satellite SAT_X based on at least one of the following information: a link budget between the first satellite SAT_X and the cell CELL; the trajectories of the satellites SAT_X and SAT_Y; the geographical coordinates defining the cell CELL.

During a step SX90, as a function of the information COOP_DIM, the first satellite SAT_X sends a cooperation query COOP_QUERY (received during a step SY90) to the second satellite SAT_Y. The cooperation query COOP_QUERY is a query to transmit data to said at least one terminal UE. According to one embodiment, the query COOP_QUERY comprises control data, for example one or more of the following information: channels to be used, cells, emission power levels, emission durations, and synchronization information. In particular, the synchronization information allows the satellites SAT_X and SAT_Y to coordinate their emissions so that the signals emitted by the satellites are synchronously received by a receiver.

During a step SX100, according to one particular embodiment, the first satellite SAT_X receives, from the second satellite SAT_Y, a response COOP_ACK to the query COOP_QUERY (sent during a step SY100). According to one embodiment, the response COOP_ACK comprises information COOP_START indicating that the satellite SAT_Y is available to cooperate, or information COOP_STOP indicating a downtime.

During a step SX110, the first satellite SAT_X receives data DATA from the ground station GW (sent by the server SERVER, the network entity NE and the ground station GW respectively during steps SS110, SN110, and SG110). The data DATA can comprise data COOP_DATA and also data DATA_X. The data DATA are for example emitted by the server SERVER comprised in the computer network NET.

During a step SX120, the first satellite SAT_X sends, to the second satellite SAT_Y, the data COOP_DATA to be transmitted to said at least one terminal UE (received during a step SY120).

During a step SX130, according to one embodiment, the first satellite SAT_X sends the data DATA_X (received during a step SU130) to said at least one terminal UE. The first satellite transmits the data DATA_X for example by using a time-frequency block (CH1, T1). The data DATA_X can be different from or identical to the data COOP_DATA.

It should be noted that if step SX130 is not implemented, then the inter-satellite cooperation is of the relay type; otherwise, if step SX130 is implemented, then the inter-satellite cooperation is of the CoMP or carrier aggregation type as previously described with reference to FIG. 1.

During a step SY140, the second satellite SAT_Y sends the data COOP_DATA to said at least one terminal UE. According to one embodiment, the second satellite SAT_Y sends the data COOP_DATA by using a time-frequency block (CH1, T1) identical to the time-frequency block used by the first satellite SAT_X to send the data DATA_X; and according to another embodiment, the second satellite SAT_Y sends the data COOP_DATA by using a different time-frequency block (CH2, T1).

If, during step SY140, the second satellite SAT_Y uses a time-frequency block (CH1, T1) identical to the time-frequency block used by the first satellite SAT_X, then the inter-satellite cooperation is of the CoMP type as previously described with reference to FIG. 1. If, during step SY140, the second satellite SAT_Y uses a time-frequency block (CH2, T1) different from the time-frequency block used by the first satellite SAT_X, then the inter-satellite cooperation is of the carrier aggregation type as previously described with reference to FIG. 1.

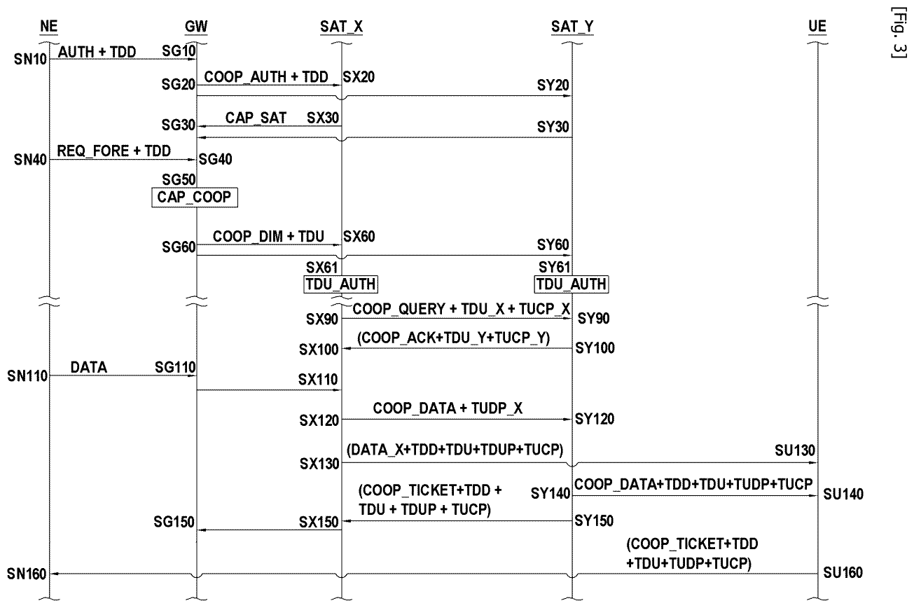

FIG. 3 represents, in the form of a flowchart, steps of a communication method according to one embodiment of the invention.

According to one embodiment illustrated in FIG. 3, the communication system implements a method for monitoring a resource usage to communicate with said at least one terminal UE. This embodiment particularly allows to achieve reliable and accurate traceability of the resources used during inter-satellite cooperation to communicate data to a terminal.

This embodiment can of course be combined with the four embodiments previously described, particularly the embodiments described with reference to FIGS. 1 and 2. This embodiment thus allows to monitor a resource usage during cooperation between network devices, particularly cooperation of the relay, COMP, carrier aggregation, or long handover type.

According to this embodiment, the communication system SYS comprises at least one resource usage monitoring entity. As an example, it is considered below that this monitoring entity is comprised in the network entity NE of the system SYS. It should however be noted that this example is not limiting and other embodiments could be envisaged in which this monitoring entity is comprised in any one or each of the elements of the system SYS. In particular, the communication system SYS can comprise a plurality of monitoring entities. According to one embodiment, the system SYS comprises: a first monitoring entity comprised in the network entity NE exploited by a mobile operator MNO; and a second monitoring entity comprised in a ground station GW exploited by a satellite operator SNO.

In comparison with FIG. 2, the method according to this embodiment further comprises at least one of the steps described below. More specifically, the steps of FIG. 3 either describe additional steps compared to the steps of FIG. 2, or specify the implementation of the steps of FIG. 2 according to embodiments of the invention.

During a step SG10, the ground station GW receives, from a certified entity NE, one or more resource delegation authorizations TDD comprising respectively a public key associated with the certified network entity NE (sent during a step SN10). The authorizations TDD (i.e. delegation rights) indicate resources that can be exploited by network devices, particularly the satellites SAT_X and SAT_Y, to implement cooperation between network devices in order to communicate with terminals.

Hereinafter, the reference signs starting with T designate information or a token type message comprising, according to one embodiment, a signature for authenticating the author of a data block and checking its integrity. A token also allows to identify this data block which is therefore not retransmitted, if it is assumed to be known to the recipient. In particular, the messages COOP_TICKET, described below with reference to steps SX150 and SU160, group the different tokens in order to have at least the signatures of the network devices participating in the cooperation, the associated data (i.e. transmitted during the cooperation) not being necessarily comprised in the messages COOP_TICKET.

During a step SG20, the ground station GW sends the authorizations TDD_X, TDD_Y to the satellites SAT_X and SAT_Y (received during steps SX20 and SY20). For example, an authorization TDD can be issued by the network entity NE exploited by a mobile operator MNO owning a certain frequency spectrum. In this example, by means of the authorization TDD, a mobile operator MNO authorizes a satellite operator SNO to exploit all or part of the spectrum owned by the operator MNO to communicate data to terminals UE.

During a step SG40, the ground station GW receives, from the certified entity NE, one or more authorizations to use resources TDU comprising respectively a signature determined from a private key associated with the certified entity NE (sent during a step SN40). The authorizations TDU (i.e. usage rights) indicate resources that can be used by network devices, particularly the satellites SAT_X and SAT_Y, to communicate with terminals.

During a step SG60, the ground station GW sends the authorizations TDU_X, TDU_Y to the satellites SAT_X and SAT_Y (received during the steps SX60 and SY60). For example, an authorization TDU can be issued by a mobile operator MNO and indicate the usable frequency spectra. According to this example, a mobile operator MNO can authorize, by an authorization TDU_X, the first satellite SAT_X to use a frequency channel between 3.510 GHz and 3.529 GHz in order to communicate with terminals.

According to one embodiment, the signature of a message is obtained by encrypting a hash of the message with the private key. Thus, upon receipt of the message, the recipient simply has to decrypt the signature of the message with the sender's public key, and then compare the decrypted signature to a hash of the message received to ensure the authenticity and the integrity of the message.

The satellites SAT_X and SAT_Y respectively perform a step of authenticating SX61 and SY61 spectrum use authorizations TDU based on the signatures and the public keys received, for example those of the TDDs. This embodiment allows to reliably and securely monitor the exploitation of the resources, particularly during inter-satellite cooperation.

Hereinafter, the information TUCP and TUDP designates resource usage proofs used by network devices to communicate with at least one terminal. More particularly, information TUCP and TUDP designates respectively resource usage proofs used to communicate control data and to communicate application data.

During a step SX90, the first satellite SAT_X sends to the second satellite SAT_Y: a cooperation query COOP_QUERY; information TUCP_X; and an authorization TDU_X (received during a step SY90). The information TUCP_X indicates, for example, a number of time-frequency blocks used by the first satellite SAT_X to transmit the query COOP_QUERY; and the authorization TDU_X is used to indicate the spectrum exploited.

During a step SX100, according to one particular embodiment, the first satellite SAT_X receives from the second satellite SAT_Y: a response COOP_ACK; information TUCP_Y; and an authorization TDU_Y (sent during a step SY100). For example, the information TUCP_Y indicates a number of time-frequency blocks used by the second satellite SAT_Y to transmit the response COOP_ACK; and the authorization TDU_Y is used to indicate the spectrum exploited.

During a step SX120, the first satellite SAT_X sends to the second satellite SAT_Y: data COOP_DATA; and information TUDP_X (received during a step SY120). For example, the information TUDP_X indicates a number of time-frequency blocks used by the first satellite SAT_X to transmit the data COOP_DATA.

During a step SX130, according to one embodiment, the first satellite SAT_X sends to said at least one terminal UE: the data DATA_X; the authorizations TDD_X and TDU_X; and information TUDP_X (received during a step SU130). For example, the information TUDP_X indicates a number of time-frequency blocks used by the first satellite SAT_X to send the data COOP_DATA and the data DATA_X; and the authorizations TDD_X, TDU_Y allow the receiver to authenticate the information transmitted as well as to identify the resources used by the first satellite SAT_X.

During a step SY140, the second satellite SAT_Y sends to said at least one terminal UE: the data COOP_DATA; the authorizations TDD_Y and TDU_Y; and information TUCP_Y and TUDP_Y (received during a step SU140). For example, the information TUCP_Y and TUDP_Y indicates a number of time-frequency blocks used by the second satellite SAT_Y to send the response COOP_ACK and the data COOP_DATA; and the authorizations TDD_Y, TDU_Y allow the receiver to authenticate the transmitted information as well as to identify the resources used by the second satellite SAT_Y.

During a step SY150, the second satellite SAT_Y sends, to the first satellite SAT_X, a message COOP_TICKET comprising: the authorizations TDD_Y and TDU_Y; and information TUCP_Y and TUDP_Y. For example, the information TUCP_Y and TUDP_Y indicates all or part of the resources used by the second satellite SAT_Y during the cooperation.

During a step SX150, according to one particular embodiment, the first satellite SAT_X sends, to the second monitoring entity comprised in the ground station GW, a message COOP_TICKET comprising: the authorizations TDD_X, TDD_Y, TDU_X and TDU_Y; and information TUCP_X, TUCP_Y, TUDP_X and TUDP_Y (received and transmitted by the ground station GW during a step SG150). In this way, the monitoring entity comprised in the ground station GW is able to accurately monitor and account for the resources used by the first satellite SAT_X and the second satellite SAT_Y to communicate data to said at least one terminal UE.

During a step SU160, following the receipt of the data DATA_X and COOP_DATA, said at least one terminal UE sends a message COOP_TICKET to the first monitoring entity comprised in the network entity NE (received during a step SN160). The message COOP_TICKET comprises: the authorizations TDD_X, TDD_Y, TDU_X and TDU_Y; and information TUCP_X, TUCP_Y, TUDP_X and TUDP_Y, received from the satellites SAT_X and SAT_Y. In this way, the monitoring entity comprised in the network entity NE is able to monitor the resources used by the satellites to communicate data to the terminal and to prove that a communication has been actually performed.

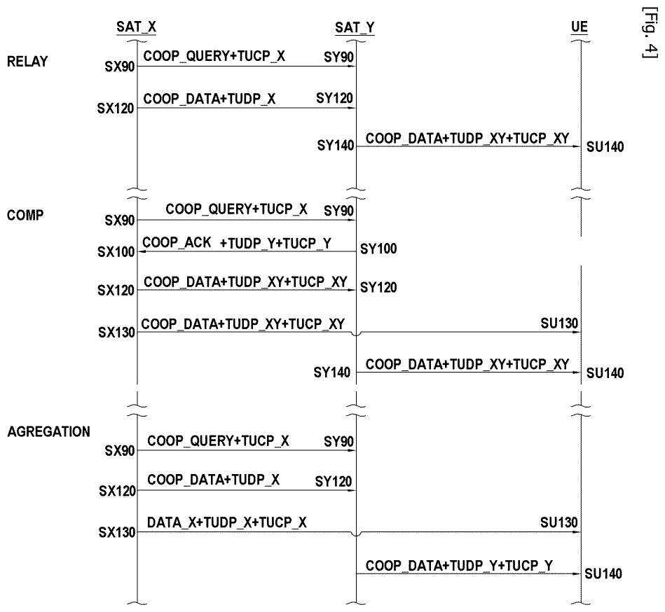

FIG. 4 represents, in the form of a flowchart, steps of a communication method according to one embodiment of the invention.

According to a first embodiment, the inter-satellite cooperation is of the relay type, the second satellite SAT_Y being exploited as a relay between the first satellite SAT_X and said at least one terminal UE. In this embodiment, the monitoring of the resources used by the satellites SAT_X and SAT_Y to communicate data COP_DATA to said at least one terminal UE can be implemented in the following manner.

During a step SY90, the second satellite SAT_Y receives, from the first satellite SAT_X: a cooperation query COOP_QUERY; and information TUCP_X relating to the resources used by the first satellite SAT_X to send the cooperation query COOP_QUERY.

During a step SY120, the second satellite SAT_Y receives, from the first satellite SAT_X: data COOP_DATA to be transmitted to said at least one terminal UE; and information TUDP_X relating to the resources used by the first satellite SAT_X to send the data COOP_DATA.

During a step SY140, the second satellite SAT_Y sends, to said at least one terminal: the data COOP_DATA; and information TUCP_X, TUCP_Y, TUDP_X, and TUDP_Y. The information TUCP_Y and TUDP_Y relates to the resources used by the second satellite SAT_Y to send a response COOP_ACK to the query COOP_QUERY and to communicate the data COOP_DATA.

In this embodiment, a terminal UE receives the data COOP_DATA as well as the information relating to the resources used by the two satellites SAT_X and SAT_Y to communicate these data. Particularly, the terminal UE sends the received information to the monitoring entity NE. The monitoring entity NE is thus able to trace the achievement of the communication and the inter-satellite cooperation implemented to communicate the data.

According to a second embodiment, the inter-satellite cooperation implemented by the communication system is of the COMP type. According to this embodiment, the first satellite SAT_X and the second satellite SAT_Y are exploited to transmit data COOP_DATA to said at least one terminal UE in a coordinated manner. This embodiment allows to increase the power of the signal received by the terminals UE and thus to improve the communication performance in terms of coverage and reliability.

During a step SY90, the second satellite SAT_Y receives, from the first satellite SAT_X: a cooperation query COOP_QUERY; and information TUCP_X relating to the resources used by the first satellite SAT_X to send the cooperation query COOP_QUERY.

During a step SY100, the second satellite SAT_Y sends, to the first satellite SAT_X: a response COOP_ACK; and information TUDP_Y and TUCP_Y relating to the resources used by the second satellite SAT_Y to send the response COOP_QUERY and the data COOP_DATA.

During a step SY120, the second satellite SAT_Y receives, from the first satellite SAT_X: data COOP_DATA to be transmitted to said at least one terminal UE; and information TUCP_X, TUCP_Y, TUDP_X, and TUDP_Y relating to the resources used by the two satellites SAT_X and SAT_Y to communicate the data COOP_DATA to said at least one terminal UE.

During a step SX130, the first satellite SAT_X sends, to said at least one terminal UE: data COOP_DATA; and the information TUCP_X, TUCP_Y, TUDP_X, and TUDP_Y relating to the resources used by the two satellites SAT_X and SAT_Y to communicate the data COOP_DATA to said at least one terminal UE.

During a step SY140, the second satellite SAT_Y sends, to said at least one terminal UE: the data COOP_DATA; and the information TUCP_X, TUCP_Y, TUDP_X, and TUDP_Y relating to the resources used by the two satellites SAT_X and SAT_Y to communicate the data COOP_DATA to said at least one terminal UE.

In this embodiment, a terminal UE receives the data COOP_DATA from the two satellites SAT_X and SAT_Y as well as the information relating to the resources used by the two satellites SAT_X and SAT_Y to communicate these data. Particularly, the terminal UE sends the received information to the monitoring entity NE. The monitoring entity NE is thus able to trace the achievement of the communication and the inter-satellite cooperation implemented to communicate the data.

According to a third embodiment, the inter-satellite cooperation implemented by the communication system is of the carrier aggregation type. In this embodiment, the first satellite SAT_X and the second satellite SAT_Y are exploited to simultaneously send data DATA_X and COOP_DATA to said at least one terminal UE by using different frequency resources. This embodiment allows to implement frequency multiplexing, and thus to improve the transmission rate.

During a step SY90, the second satellite SAT_Y receives, from the first satellite SAT_X: a cooperation query COOP_QUERY; and information TUCP_X relating to the resources used by the first satellite SAT_X to send the cooperation query COOP_QUERY.

During a step SY100, the second satellite SAT_Y sends, to the first satellite SAT_X: a response COOP_ACK; and information TUDP_Y and TUCP_Y relating to the resources used by the second satellite SAT_Y to send the response COOP_QUERY and the data COOP_DATA.

During a step SY120, the second satellite SAT_Y receives, from the first satellite SAT_X: data COOP_DATA to be transmitted to said at least one terminal UE; and information TUDP_X relating to the resources used by the first satellite SAT_X to communicate the data COOP_DATA to the second satellite SAT_Y.

During a step SX130, the first satellite SAT_X sends, to said at least one terminal UE: data DATA_X; and the information TUCP_X and TUDP_X relating to the resources used by the first satellite SAT_X to communicate the data DATA_X to said at least one terminal UE.

During a step SY140, the second satellite SAT_Y sends, to said at least one terminal UE: the data COOP_DATA; and the information TUCP_Y and TUDP_Y relating to the resources used by the second satellite SAT_Y to communicate the data COOP_DATA to said at least one terminal UE.

In this embodiment, a terminal UE receives, from the first satellite SAT_X, the data DATA_X as well as the information relating to the resources used by the first satellite SAT_X to communicate the data DATA_X. In addition, the terminal UE receives, from the second satellite SAT_Y, the data COOP_DATA as well as the information relating to the resources used by the second satellite SAT_Y to communicate the data COOP_DATA. Following the receipts, the terminal UE sends the received information to the monitoring entity NE.

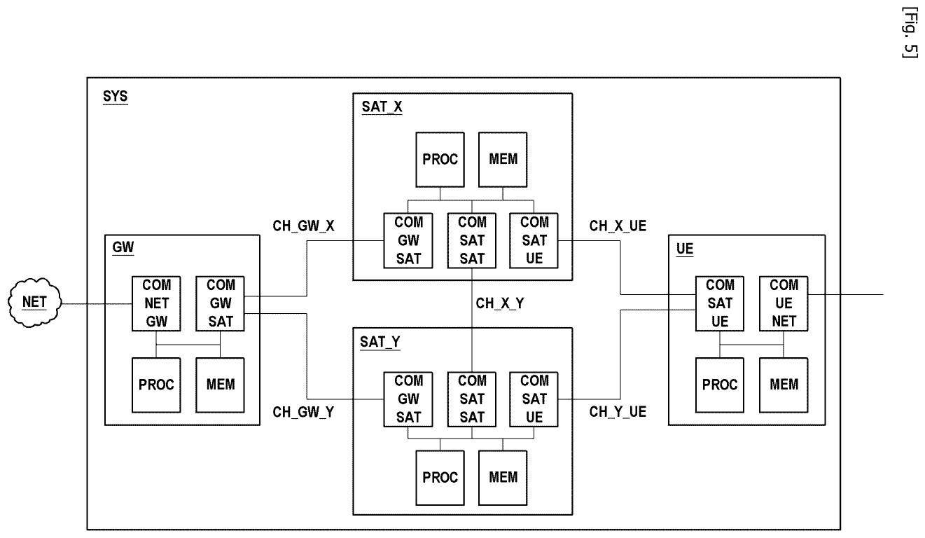

FIG. 5 schematically represents one example of software and hardware architecture of a communication system according to one embodiment of the invention.

As illustrated in FIG. 5, according to one embodiment, the ground station GW comprises at least one of the following modules: a communication module COM_NET_GW configured to communicate with the communication network NET; and a communication module COM_GW_SAT configured to communicate with at least one of the satellites SAT_X and SAT_Y.

As illustrated in FIG. 5, according to one embodiment, the satellites SAT_X and SAT_Y respectively comprise at least one of the following modules: a communication module COM_GW_SAT configured to communicate with the ground station GW; a communication module COM_SAT_SAT configured to communicate with at least one other satellite; and a communication module COM_SAT_UE configured to communicate with said at least one terminal UE.

As illustrated in FIG. 5, according to one embodiment, a said terminal UE comprises at least one of the following modules: a communication module COM_SAT_UE configured to communicate with at least satellites SAT_X and SAT_Y; and a communication module COM_UE_NET configured to communicate with the network.

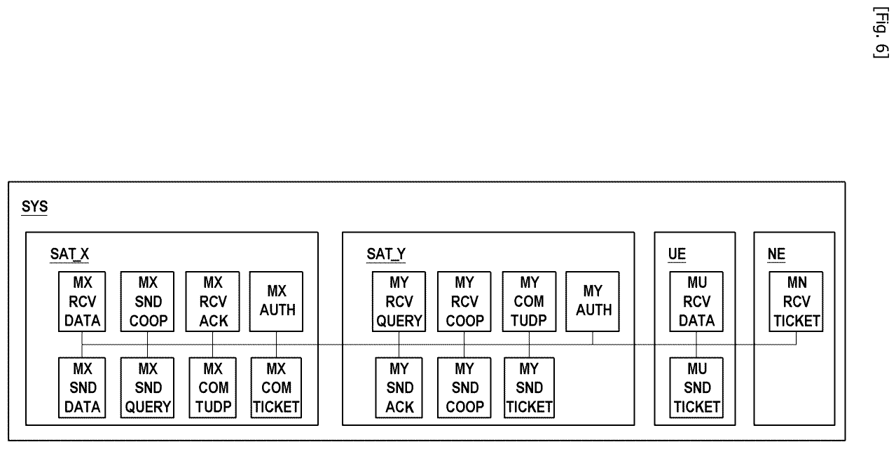

According to one embodiment, one or more elements of the communication system SYS respectively have the hardware architecture of a computer. Consider an element ELT of the communication system SYS. According to this embodiment, the element ELT includes a processor PROC, a random access memory, a read-only memory MEM, and a non-volatile memory. The memory MEM constitutes an information medium in accordance with the invention, readable by a computer and on which a computer program PROG is recorded. The computer program PROG includes instructions for the implementation of the steps performed by the element ELT of a method according to the invention, when the computer program PROG is executed by the processor PROC. The computer program PROG defines the functional modules represented below in FIG. 6, which rely on or control the hardware elements thereof.

FIG. 6 schematically represents one example of a functional architecture of a communication system according to one embodiment of the invention.

The following reference signs allow, for each of the modules of the communication system, to identify the element comprising this module: The references starting with MX for the modules of the first satellite SAT_X; MY for the second satellite SAT_Y; MU for said at least one terminal UE; and MN for the modules of the network entity NE.

As illustrated in FIG. 6, according to one embodiment, the first satellite SAT_X and the second satellite SAT_Y respectively comprise at least one of the following modules:
a receiving module MX_RCV_DATA for receiving the data DATA;
a sending module MX_SND_QUERY for sending the query COOP_QUERY;
a receiving module MX_RCV_ACK for receiving the response COOP_ACK;
a sending module MX_SND_COOP for sending the data COOP_DATA;
a sending module MX_SND_DATA for sending the data DATA_X;
a communication module MX_COM_TUDP for sending and/or receiving the information TDD, TDU, TUCP and TUDP;
an authentication module MX_AUTH for authenticating the information TDU; and
a communication module MX_COM_TICKET for receiving and/or sending the message COOP_TICKET.

As illustrated in FIG. 6, according to one embodiment, the second satellite SAT_Y comprises respectively at least one of the following modules:
a receiving module MY_RCV_QUERY for receiving the query COOP_QUERY;
a sending module MY_SND_ACK for sending the response COOP_ACK;
a receiving module MY_RCV_COOP for receiving the data COOP_DATA; and
a sending module MY_SND_COOP for sending the data COOP_DATA.
a communication module MY_COM_TUDP for sending and/or receiving the information TDD, TDU, TUCP and TUDP;
an authentication module MY_AUTH for authenticating the information TDU; and
a sending module MY_SND_TICKET for sending the message COOP_TICKET.

As illustrated in FIG. 6, according to one embodiment, a said terminal UE comprises at least one of the following modules:
a receiving module MU_RCV_DATA for receiving the data DATA_X and COOP_DATA and the information TDD, TDU, TUCP, and TUDP; and
a sending module MU_SND_TICKET for sending the message COOP_TICKET.

As illustrated in FIG. 6, according to one embodiment, the monitoring entity NE comprises a receiving module MN_RCV_TICKET for receiving the message COOP_TICKET.

The term “module” can correspond to both a software component and a hardware component or a set of hardware and software components, a software component itself corresponding to one or more computer programs or subprograms or more generally to any element of a program able to implement a function or a set of functions as described for the modules concerned. In the same way, a hardware component corresponds to any element of a set of hardware able to implement a function or a set of functions for the module concerned (integrated circuit, smart card, memory card, etc.).

It should be noted that the order in which the steps of a method as described above are linked, particularly with reference to the attached drawings, constitutes only one exemplary embodiment without any limitation, variants being possible. Moreover, the reference signs are not limiting the scope of the protection, their sole function being to facilitate the understanding of the claims.

Those skilled in the art will understand that the embodiments and variants described above constitute only non-limiting examples of implementation of the invention. In particular, those skilled in the art can envisage any adaptation or combination of the embodiments and variants described above in order to meet a very specific need.

As described above, the present invention applies in particular to the satellite communication systems. However, it is important to note that the invention also applies to all types of communication systems and networks, particularly terrestrial, satellite or aircraft communication systems. For example, the invention can apply to terrestrial or aerial mobile telephone cellular networks, or to wireless local area networks.

1. A method implemented by a network device for monitoring a resource usage to communicate with at least one terminal, the method comprising:
sending data to said at least one terminal;
sending, to a monitoring entity and/or to said at least one terminal, one or more usage proofs indicating resources used by said network device to communicate said data to said at least one terminal; and
sending, to the monitoring entity and/or to said at least one terminal, one or more usage proofs indicating resources used by at least one other network device to communicate said data to said at least one terminal.

2. The method according to claim 1 wherein said one or more usage proofs are signed by a private key associated with a certified entity.

3. The method according to claim 1 wherein said one or more usage proofs indicate:
frequency resources used to communicate said data to said at least one terminal; and/or
time-frequency resources used to communicate application data to said at least one terminal and associated control data; and/or
an amount of energy resources consumed to communicate said data to said at least one terminal.

4. The method according to claim 1 wherein said network device sends all or part of said data to said at least one terminal via another network device.

5. The method according to claim 4 wherein said sending of all or part of said data to said at least one terminal via said at least one other network device is triggered following a receipt of a usage query message received from said at least one terminal.

6. The method according to claim 1 wherein sending said data by said network device to said at least one terminal comprises:
sending a first portion of said data to said at least one terminal; and
sending, to at least one other network device, a second portion of said data to be transmitted to said at least one terminal.

7. The method according to claim 4 comprising:
sending, to said at least one other network device, a query to transmit data to said at least one terminal, said query comprising one or more usage proofs indicating resources used by said network device; and
receiving, from said at least one other network device, a response comprising one or more usage proofs indicating resources used by said at least one other network device.

8. The method according to claim 1 comprising:
receiving, from a certified entity, a public key associated with the certified entity;
receiving, from the certified entity, an authorization to use at least one resource comprising a signature determined from a private key associated with the certified entity; and
authenticating said authorization from the received signature and public key.

9. A method implemented by a terminal for monitoring a resource usage to communicate with at least one network device, the method comprising:
receiving data from said at least one network device;
receiving, from said at least one network device, one or more usage proofs indicating resources used by said at least one network device to communicate said data to the terminal;
receiving, from said at least one network device, one or more usage proofs indicating resources used by at least one other network device to communicate said data to said at least one terminal; and
sending said usage proofs to a monitoring entity.

10. A network device for communicating with at least one terminal comprising:
a sending module configured to send data to said at least one terminal; and
a sending module configured to:
send, to a monitoring entity and/or to said at least one terminal, one or more usage proofs indicating resources used by said network device to communicate said data to said at least one terminal; and to
send, to the monitoring entity and/or to said at least one terminal, one or more usage proofs indicating resources used by at least one other network device to communicate said data to said at least one terminal.

11. A terminal comprising:
a receiving module configured to:
receive, from at least one network device, data and one or more usage proofs indicating resources used by said at least one network device to communicate said data to the terminal; and to
receive, from said at least one network device, one or more usage proofs indicating resources used by at least one other network device to communicate said data to said at least one terminal; and
a sending module configured to send said usage proofs to a monitoring entity.

12. A monitoring entity comprising:
a receiving module configured to:
receive, from at least one network device and/or from at least one terminal, one or more usage proofs indicating resources used by said at least one network device to communicate data to said at least one terminal; and to
receive, from said at least one network device and/or from said at least one terminal, one or more usage proofs indicating resources used by at least one other network device to communicate said data to said at least one terminal.

13. (canceled)

14. (canceled)
